(19) United States
(12) Patent Application Publication
(10) Pub. No.: US 2005/0023222 A1
(43) Pub. Date: Feb. 3, 2005

(54) Filtration apparatus and method

(76) Inventor: Brian Baillie, Glasgow (GB)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/833,712

(22) Filed: Apr. 28, 2004

(30) Foreign Application Priority Data
May 30, 2003 (GB) 0312394.0

(51) Int. Cl. B01D 61/00

(52) U.S. Cl. 210/651; 210/321.6; 210/411; 210/416.1; 210/650

(57) ABSTRACT

A filtration apparatus for treating a fluid prior to being injected into a subterranean hydrocarbon-bearing formation includes a filtration unit having one or more filtration membranes including either or both ultra-filtration membranes and micro-filtration membranes. In one disclosed embodiment the filtration apparatus is utilised to filter a fluid prior to being treated in a sulfate removal plant. A method of treating a fluid to be injected into a subterranean formation is also disclosed.

### FIELD OF THE INVENTION

The present invention relates to a filtration apparatus and method, and in particular, but not exclusively, to an apparatus and method of filtering water to be injected into a subterranean hydrocarbon-bearing formation.

### BACKGROUND OF THE INVENTION

Extracting hydrocarbons from a subterranean formation involves flowing the hydrocarbons from the formation to surface through a production well bore. In the early stages of production, the hydrocarbons are driven into the production well and flowed to surface by the pressure within the formation. However, over time the formation pressure reduces until natural extraction can no longer be sustained, at which stage some form of artificial or assisted extraction is required. One common form or method of artificial extraction involves the injection of a fluid medium into the depleting formation through an injection well bore which extends from surface in order to displace the hydrocarbons from the formation. Conventionally, the fluid medium is aqueous and may be produced water or brine or sea water or the like.

Where water injection is utilised to displace hydrocarbons from the formation, it is important that the injection water is compatible with the formation chemistry and is substantially free from suspended or dissolved particles and colloidal and macromolecular matter. This is required to prevent or at least minimise plugging of the formation and associated wells, which occurs when precipitates or suspended particles or the like accumulate and block, or plug, fluid passageways. Such fluid passageways may include pores, fractures or cracks or the like in the hydrocarbon-bearing rock formation, or passageways defined by the production and injection well bores. This plugging can significantly reduce hydrocarbon production and in severe cases can terminate production altogether.

In order to ensure that the injection water is substantially free from suspended or dissolved particles and the like, it is known in the art to treat the water prior to injection into the formation. Treatment normally includes a combination of chemical and mechanical or physical processes. For example, coagulants or flocculants may be added to the water to encourage flocculation where heavy particles or flocculus, known as “floc”, are formed. The floc may then be removed by sedimentation and/or by filtration whereby mechanical straining removes a proportion of the particles by trapping them in a filter medium. Conventional filtration apparatus for use in treating injection water include rapid multimedia filters which consist of two or more layers of different or graded granular material such as gravel, sand and anthracite, for example. The water to be treated is passed through the filter and any suspended or dissolved particles or the like will be retained in the interstices between the granules of the different layers. It is therefore required that the filter media be regularly cleaned to maintain a sufficient filtration efficiency. Cleaning is conventionally achieved by a process known as backwashing wherein water is passed through the filter media in a reverse direction in order to dislodge the particles which have been captured by the granules of the filter. This backwashing process, while effective, results in the wastage of a large volume of treated water. Furthermore, in order to achieve adequate filtration, a large quantity of filtration media must be utilised which results in an extremely large and heavy filtration unit requiring a considerable amount of dedicated plant space which can be extremely limited on off-shore production platforms, for example.

With regards to plugging caused by precipitate formation and accumulation, this occurs when ionic species in the injection water combines or reacts with compatible ionic species in water or brine present in the formation producing a precipitate or scale. For example, sulfate anions (SO₄⁻) in the injection water will combine with Barium cations (Ba⁺⁺) in the formation water to form a barium-sulfate or barite precipitate. This precipitate is substantially insoluble making any precipitate purging and removal process extremely difficult and complicated. Various methods have thus been proposed which provide a preventative solution in that they seek to remove the problematic, or precursor ions from the injection water before injection into the formation. For example, prior art reference U.S. Pat. No. 4,723,603 assigned to Marathon Oil Company discloses a process in which a feed water is treated to remove precursor ions by a process of reverse osmosis to produce a treated injection water product. The reverse osmosis technique involves forcing the feed water through a semi-permeable membrane under pressure wherein the membrane allows water to pass while excluding the precursor ions. This reverse osmosis process is effective in removing ionic species dissolved in an aqueous solution, but the efficiency and performance of the process can depend heavily on the quality of the feed water to be treated. For example, feed water which contains large quantities of suspended solids or colloidal matter will cause fouling of the reverse osmosis membrane, thus reducing the overall efficiency of the ionic species removal process. It is therefore common to pre-treat the feed water using, for example, rapid multimedia filters as discussed above.

It is among objects of embodiments of the present invention to obviate or at least mitigate the problems associated with prior art methods of treating a fluid for injection into a hydrocarbon-bearing formation.

### SUMMARY OF THE INVENTION

According to a first aspect of the present invention, there is provided an apparatus for treating a fluid to be injected into a subterranean hydrocarbon-bearing formation, said apparatus comprising:

a filtration unit having a fluid inlet and a first fluid outlet, said fluid inlet and first fluid outlet being in fluid communication via a fluid passage; and

at least one filtration membrane located within said fluid passage such that the fluid inlet and first fluid outlet are in fluid communication through the at least one filtration membrane, wherein said at least one filtration membrane includes at least one of an ultra-filtration membrane and a micro-filtration membrane.

Thus, a fluid to be injected into a subterranean hydrocarbon-bearing formation may be flowed through the filtration unit and through the at least one filtration membrane such that any colloids, flocculants, particulates and high molecular mass soluble species and the like will be retained by the membrane by a mechanism of size exclusion to concentrate, fraction or filter dissolved or suspended species within the fluid.

Advantageously, the fluid inlet is adapted to be coupled to a fluid source for fluid communication therewith. The fluid source may be a reservoir or the like of seawater, for example, or water or brine produced from a subterranean formation.

Conveniently, the fluid inlet of the apparatus is adapted to be coupled to the fluid source via a pre-filtration unit. Preferably, the pre-filtration unit comprises strainers having sieve sizes of between 80 to 150 microns. Thus, the water intended to be fed to the apparatus of the present invention may be pre-filtered in order to remove larger suspended particles and the like which may block or foul the at least one membrane located within the filtration unit.

Preferably, the apparatus includes a plurality of membranes arranged within the filtration unit. The membranes may consist entirely of ultra-filtration membranes, or entirely of micro-filtration membranes, or a combination thereof.

Conveniently, the at least one filtration membrane defines a plurality of pores each having a diameter or equivalent dimension of between 0.005 to 0.1 micron for ultrafiltration membranes and 0.05 to 2 microns for micro-filtration membranes.

In one embodiment of the present invention, the at least one membrane may compromise a ceramic material. Alternatively, the at least one membrane may compromise a polymeric material. It should be understood that any suitable material or materials may be used to form the at least one membrane in accordance with the performance requirements of the apparatus and the operating parameters such as quality of feed water, required injection water quality, and injection water flow rates and the like. Suitable polymeric membrane materials include PVDF, polypropylene, polysulfone, cellulosic and other proprietary formulations.

Advantageously, where a plurality of membranes are provided, each membrane may comprise the same or different materials, as required.

Conveniently, the at least one membrane is adapted to operate at temperatures in the region of, for example, up to 40° C. for polymeric materials, and much higher temperatures for ceramic membranes.

Conveniently also, the at least one membrane is adapted to operate at pressures in the region of, for example 2.0 to 5 bar, depending on the required filtrate backpressure.

Advantageously, the at least one membrane is adapted for use with water comprising chemical additives such as coagulants, flocculants, disinfectants and pH stabilisers and the like in order to improve treatment efficiency.

Preferably, means are provided for creating a pressure differential between the fluid inlet and the fluid outlet such that the fluid to be treated is pressure driven through the at least one filtration membrane. Advantageously, the pressure differential is created by way of pumping means, which pumping means may be located upstream of the apparatus, and which may take any appropriate form.

Advantageously, the pressure gradient provided by the pressure differential is reversible in order to reverse the fluid flow through the at least one membrane to effect backwashing.

Depending on the service mode of the filtration membrane, as discussed below, the filtration unit may comprise a second fluid outlet to provide an exit for unfiltered fluid. It should be appreciated that such unfiltered fluid will likely have a higher concentration of particulates, colloids and suspended matter and the like than the feed water, as the solid matter retained by the at least one filtration membrane will be entrained into the stream of fluid directed and flowed towards the second fluid outlet. Thus, the feed fluid entering the filtration unit will be separated into two fluid streams, the first being filtered water or filtrate driven through the at least one filtration membrane and exiting through the first fluid outlet, and the second being unfiltered or concentrated water exiting through the second fluid outlet. The provision of the second fluid outlet and thus second flow path assists in cleaning the at least one filtration membrane, reducing the amount of backwashing required and maintaining a reasonably high filtration efficiency.

Ultrafiltration (UF) and microfiltration (MF) membranes are operated in two different service modes: dead-end flow and cross-flow. In the dead-end flow mode of operation (also known as direct-flow) there is only a feed flow and a filtrate flow (no concentrate flow). The dead-end flow approach typically allows for optimal recovery of feed water in the 95 to 98% range, but is typically limited to feed streams of low suspended solids (typically <10 NTU turbidity). In the cross-flow mode of operation, a concentrate flow is added to the feed and filtrate flows. The cross-flow mode is typically used for feed waters with higher suspended solids (typically 10 to 100 NTU turbidity). The cross-flow mode of operation typically results in 90 to 95% recovery of the feed water.

In one embodiment of the present invention, the first fluid outlet is adapted to be in fluid communication with an injection well bore wherein fluid leaving the filtration unit via the first fluid outlet is injected directly into the formation via the injection well bore.

In an alternative embodiment of the present invention, the fluid outlet of the filtration unit is adapted to be in fluid communication with an ionic species removal plant. Thus, treated fluid from the filtration plant of the apparatus of the present invention may be flowed to the ionic species removal plant, located downstream of the filtration plant, in order to be further treated before being injected into the formation. The ionic species removal plant may be, for example, a sulfate removal plant adapted to remove sulfate anions (SO₄⁻) from the injection water. Thus, by locating the ionic species removal plant downstream of the filtration unit of the apparatus of the present invention, fouling of the ionic species plant by particles and colloids and the like is substantially reduced. This arrangement improves the performance of the ionic species removal plant and also reduces the amount of cleaning required which conventionally involves the use of potent chemicals which require safe disposal when spent.

Conveniently, the apparatus is adapted to be coupled to a deaerator in order to remove air and other gases from the injection water in order to prevent aerobic bacteria growth during the injection process. Preferably, the deaerator is located downstream of the apparatus of the present invention. Alternatively, the deaerator may be located upstream of the apparatus.

Preferably, the apparatus operates with a specific flux of litres of treated product water per metre square of filtration membrane per hour of between 20 l/m²/h to 250 l/m²/h. More preferably, the specific operating flux of the apparatus of the present invention is 80 l/m²/h to 120 l/m²/h.

Preferably also, the operating pH of the filtered water may be adjusted within the range 2 to 13. More preferably, the operating pH range is 6.5 to 8.5, depending on the membrane material used.

According to a second aspect of the present invention, there is provided a method of treating water to be injected into a subterranean hydrocarbon-bearing formation, said method comprising the steps of:

flowing injection water through an inlet of a filtration unit comprising at least one filtration membrane being at least one of an ultra-filtration membrane and a micro-filtration membrane;

driving said injection water through said at least one filtration membrane; and

flowing said injection water through an outlet of the filtration unit.

Preferably, the method further involves the step of flowing the injection water through a pre-filtration unit prior to flowing said water through the inlet of the filtration unit.

Conveniently, the method may further include the step of flowing the water through a deaerator, either prior to, or after the water has been filtered by the filtration unit.

Advantageously, the method may further involve the step of flowing the water through an ionic species removal plant, such as a sulfate removal plant, after the water has been filtered by the filtration unit.

According to a third aspect of the present invention, there is provided a system for treating water to be injected into a subterranean hydrocarbon-bearing formation, the system comprising:

a filtration unit comprising at least one filtration membrane being at least one of an ultra-filtration membrane and a micro-filtration membrane; and

injection pump means coupled to the filtration unit and adapted for pressurising water from the filtration unit to be injected into a hydrocarbon-bearing formation.

According to a fourth aspect of the present invention, there is provided a system for treating water to be injected into a subterranean hydrocarbon-bearing formation, the system comprising:

a filtration unit comprising at least one filtration membrane being at least one of an ultra-filtration membrane and a micro-filtration membrane;

an ionic species removal plant coupled to the filtration unit; and

injection pump means for pressurising treated water to be injected into a hydrocarbon-bearing formation.

Advantageously, the system may further comprise a pre-filtration unit coupled between the filtration unit and a fluid source.

Conveniently, the system may further comprise a deaerator which may be coupled between the filtration unit and the fluid source, or alternatively between the ionic species removal plant and the injection pump means.

Preferably, the ionic species removal plant is a sulfate removal plant.

### BRIEF DESCRIPTION OF THE DRAWINGS

These and other aspects of the present invention will now be described, by way of example only, with reference to the accompanying drawings, in which:

FIGS. 1 to 4 are diagrammatic representations of apparatus for filtering water to be injected into a subterranean hydrocarbon-bearing formation in accordance with four separate embodiments of the present invention.

### DETAILED DESCRIPTION OF THE DRAWINGS

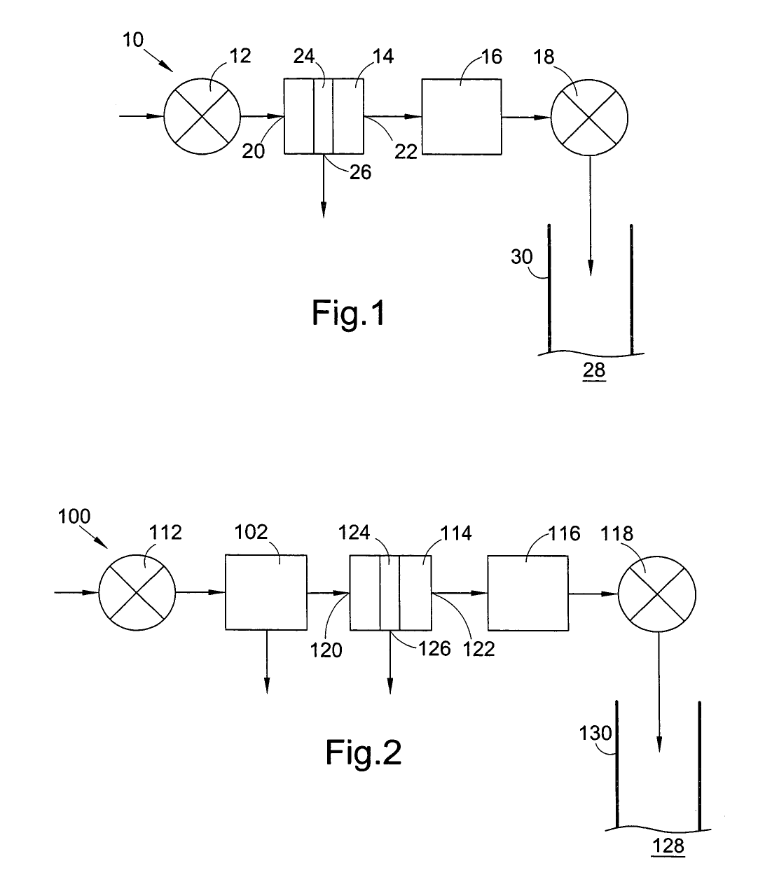

Reference is first made to FIG. 1 in which a diagrammatic representation of a water treatment apparatus or system 10 is shown in accordance with an embodiment of the present invention. The system includes a drive pump 12, a filtration unit 14, a deaerator 16 and an injection pump 18. The filtration unit 14 includes a fluid inlet 20 and a first fluid outlet 22, between which fluid inlet 20 and first fluid outlet 22 there is located a bank of filtration membranes 24. In the embodiment shown, the bank of membranes 24 is composed of ultra-filtration membranes which define pores having diameters or equivalent dimensions of between 0.005 to 0.1 micron. In an alternative embodiment the bank of membranes 24 is composed of micro-filtration membranes which define pores having diameters or equivalent dimensions of between 0.05 to 2 microns.

Feed water from a fluid source (not shown) is pressurised to between 2 to 5 bar (depending on the filtrate backpressure required) by the drive pump 12 and is driven into the inlet 20 of the filtration unit 14. The water is forced through the bank of membranes 24 under pressure such that any colloids, flocculants, particulates and high molecular mass soluble species and the like will be retained by the membranes 24 by a mechanism of size exclusion to concentrate, fraction or filter dissolved or suspended species within the water. As shown, the filtration unit 14 includes a second fluid outlet 26 through which unfiltered water may exit carrying the particles and colloids and the like retained by the bank of membranes 24. Upon leaving the filtration unit 14 through the first fluid outlet 22, the filtered water passes through the deaerator 16 where air and other gasses are removed. Finally, the treated water from the deaerator is pressurised by the injection pump 18 and is injected into a depleting hydrocarbon-bearing formation 28 via a cased injection well bore 30.

A water treatment system 100 in accordance with a second embodiment of the present invention is shown in FIG. 2. This second embodiment is essentially identical to that shown in FIG. 1 and as such like components share the same reference numerals, incremented by 100. However, and as shown, a pre-filtration unit 102 is located upstream of the filtration unit 114 and comprises strainers having sieve sizes of between 80 to 150 microns. Thus, the water intended to be fed to the filtration unit 114 is pre-filtered in order to remove larger suspended particles which may block or foul the bank of membranes located within the filtration unit 114.

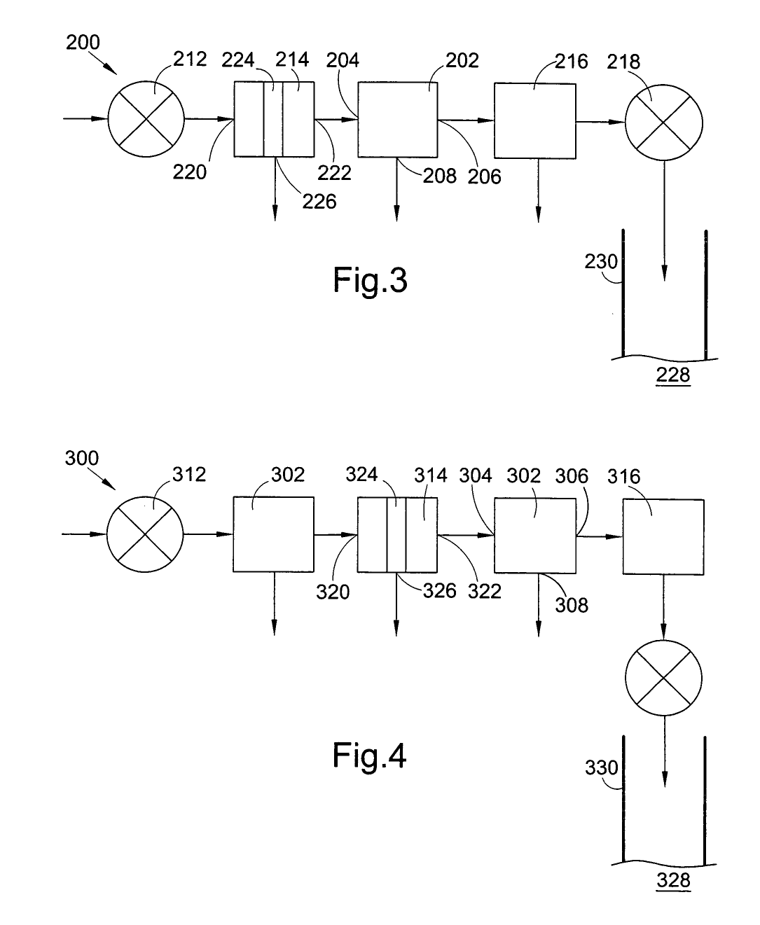

As illustrated in FIG. 3, a third embodiment of the water treatment apparatus 200 is shown which is similar to that embodiment shown in FIG. 1, and as such like components are identified with the same reference numerals, incremented by 200. In the water treatment apparatus 200 of FIG. 3, a sulfate removal plant 202 is shown located between the filtration unit 214 and the deaerator 216, and thus downstream of the filtration unit 214. Thus, water entering the sulfate removal plant 202 through inlet 204 will be substantially free from particulates and colloids and the like which will thus substantially reduce or prevent fouling of the plant 202. As shown, water to be injected exits the sulfate removal plant through a first fluid outlet 206, and high sulfate concentrated water will exit plant 202 through a second fluid outlet 208.

Reference is now made to FIG. 4 of the drawings in which there is shown a water treatment apparatus 300 in accordance with a fourth embodiment of the present invention. The apparatus 300 of FIG. 4 is essentially a combination of the embodiments 100, 200 shown in FIGS. 2 and 3 respectively, and as such like components share the same reference numerals prefixed by 3. As shown, the water treatment apparatus or system 300 includes a drive pump 312 which drives water from a source (not shown) through a pre-filtration unit 302 and into a filtration unit 324 comprising a bank of ultra-filtration (or microfiltration) membranes 324 to produce water filtrate. This filtrate exits the filtration unit through a first outlet 322 and is driven through an inlet 304 of a sulfate removal plant 302 where sulfate anions are removed from the water. The water is then flowed from the plant 302 and through a deaerator 316 to remove air or other gasses from the water. Finally, deaerated water is pressurised by injection pump 318 and injected into a formation 328 via a cased injection well bore 330.

It should be understood that the various embodiments described above are merely exemplary of the present invention and that various modifications may be made thereto without departing from the scope of the invention. For example, although the deaerator is illustrated in the figures only directly upstream of the injection pump, the deaerator may alternatively be located directly upstream of the filtration unit, downstream of the filtration unit, or downstream of the sulfate removal unit.

1. An apparatus for treating a fluid to be injected into a subterranean hydrocarbon-bearing formation, said apparatus comprising:
a filtration unit having a fluid inlet and a first fluid outlet, said fluid inlet and first fluid outlet being in fluid communication via a fluid passage; and
at least one filtration membrane located within said fluid passage such that the fluid inlet and first fluid outlet are in fluid communication through the at least one filtration membrane, wherein said at least one filtration membrane is selected from a group consisting of an ultra-filtration membrane and a micro-filtration membrane.

2. An apparatus as claimed in claim 1, wherein the fluid inlet is adapted to be coupled to a fluid source for fluid communication therewith.

3. An apparatus as claimed in claim 2, wherein the fluid source is a reservoir of seawater.

4. An apparatus as claimed in claim 2, wherein the fluid source is fluid produced from a subterranean formation.

5. An apparatus as claimed in claim 2, wherein the fluid inlet of the apparatus is adapted to be coupled to the fluid source via a pre-filtration unit.

6. An apparatus as claimed in claim 5, wherein the pre-filtration unit comprises strainers having sieve sizes of between 80 to 150 microns.

7. An apparatus as claimed in claim 1, wherein the apparatus includes a plurality of filtration membranes arranged within the filtration unit.

8. An apparatus as claimed in claim 7, wherein each of the plurality of membranes comprises an ultra-filtration membrane.

9. An apparatus as claimed in claim 7, wherein each of the plurality of membranes comprises a micro-filtration membrane.

10. An apparatus as claimed in claim 7, wherein the plurality of membranes consist of a combination of ultra-filtration membranes and micro-filtration membranes.

11. An apparatus as claimed in claim 1, wherein the at least one filtration membrane defines a plurality of pores each having a diameter or equivalent dimension of between 0.005 to 0.1 microns for said at least one ultra-filtration membrane and 0.05 to 2 microns for said at least one micro-filtration membrane.

12. An apparatus as claimed in claim 1, wherein the at least one filtration membrane is formed of a ceramic material.

13. An apparatus as claimed in claim 1, wherein the at least one filtration membrane is formed of a polymeric material.

14. An apparatus as claimed in claim 1, wherein the at least one membrane is adapted to operate at pressures in a range of 2.0 to 5 bar.

15. An apparatus as claimed in claim 1, wherein the at least one membrane is adapted for use with fluid comprising chemical additives.

16. An apparatus as claimed in claim 1, further comprising means for creating a pressure differential between the fluid inlet and the fluid outlet such that the first fluid to be treated is pressure driven through the at least one filtration membrane.

17. An apparatus as claimed in claim 16, wherein the pressure differential is created by way of pumping means.

18. An apparatus as claimed in claim 16, wherein the pressure differential comprises a reversible pressure gradient, in order to reverse the fluid flow through the at least one membrane to effect backwashing.

19. An apparatus as claimed in claim 1, wherein the filtration unit comprises a second fluid outlet to provide an exit for unfiltered fluid.

20. An apparatus as claimed in claim 1, wherein the first fluid outlet is adapted to be in fluid communication with an injection well bore wherein fluid leaving the filtration unit via the first fluid outlet is injected directly into the formation via the injection well bore.

21. An apparatus as claimed in claim 1, wherein the first fluid outlet of the filtration unit is adapted to be in fluid communication with an ionic species removal plant.

22. An apparatus as claimed in claim 21, wherein the ionic species removal plant is a sulfate removal plant adapted to remove sulfate anions (SO₄⁻) from the injection fluid.

23. An apparatus as claimed in claim 1, wherein the apparatus is adapted to be coupled to a deaerator in order to remove air and other gases from the fluid to be injected.

24. An apparatus as claimed in claim 1, wherein the apparatus operates with a specific flux of litres of treated product fluid per metre square of filtration membrane per hour of between 20 l/m²/h to 250 l/m²/h.

25. An apparatus as claimed in claim 1, wherein the apparatus operates with a specific flux of litres of treated product fluid per metre square of filtration membrane per hour of between 80 l/m²/h to 120 l/m²/h.

26. An apparatus as claimed in claim 1, wherein the operating pH of fluid passed through said filtration unit is adjustable within a range of 2 to 13.

27. An apparatus as claimed in claim 1, wherein the operating pH of fluid passed through said filtration unit is adjustable within a range of 6.5 to 8.5.

28. A method of treating fluid to be injected into a subterranean hydrocarbon-bearing formation, said method comprising the steps of:
flowing injection fluid through an inlet of a filtration unit comprising at least one filtration membrane selected from a group consisting of an ultra-filtration membrane and a micro-filtration membrane;
driving said injection fluid through said at least one filtration membrane; and
flowing said injection fluid through an outlet of the filtration unit.

29. The method of claim 28, further comprising the step of flowing the injection fluid through a pre-filtration unit prior to flowing said water through the inlet of the filtration unit.

30. The method of claim 28, further comprising the step of flowing the fluid through a deaerator.

31. The method of claim 28, further comprising the step of flowing the fluid through an ionic species removal plant after the fluid has been filtered by the filtration unit.

32. A system for treating fluid to be injected into a subterranean hydrocarbon-bearing formation, the system comprising:
a filtration unit comprising at least one filtration membrane selected from a group consisting of an ultra-filtration membrane and a micro-filtration membrane; and
injection pump means coupled to the filtration unit and adapted for pressurising fluid from the filtration unit to be injected into a hydrocarbon-bearing formation.

33. A system for treating fluid to be injected into a subterranean hydrocarbon-bearing formation, the system comprising:
a filtration unit comprising at least one filtration membrane selected from a group consisting of an ultra-filtration membrane and a micro-filtration membrane;
an ionic species removal plant coupled to the filtration unit; and
injection pump means for pressurising treated fluid to be injected into a hydrocarbon-bearing formation.
